(19) United States
(12) Patent Application Publication
(10) Pub. No.: US 2026/0093427 A1
(43) Pub. Date: Apr. 2, 2026

(54) PRINTER APPARATUS, ARTICLE MANAGEMENT APPARATUS, AND ARTICLE MANAGEMENT METHOD FOR ARTICLE MANAGEMENT APPARATUS

(71) Applicant: Toshiba Tec Kabushiki Kaisha, Tokyo (JP)

(72) Inventor: Naoya SATO, Izunokuni Shizuoka (JP)

(21) Appl. No.: 19/292,472

(22) Filed: Aug. 6, 2025

(30) Foreign Application Priority Data
Oct. 1, 2024 (JP) 2024-172693

(51) Int. Cl. G06F 3/12; G06F 16/3329; H04W 84/18

(52) U.S. Cl. CPC G06F 3/1236; G06F 3/1203; G06F 3/1292; G06F 16/3329; H04W 84/18

(57) ABSTRACT

According to an embodiment, a printer apparatus controls a tag reader or a wireless communication module that receives information from a wireless tag located nearby to acquire a search result based on search information for each node of a communication path of a mesh network from its own node toward a terminal node. The printer apparatus controls a printing device to print the search result for each node of the communication path of the mesh network from its own node toward the terminal node.

### CROSS-REFERENCE TO RELATED APPLICATIONS

This application is based upon and claims the benefit of priority from the prior Japanese Patent Application No. 2024-172693, filed on October 1, 2024, the entire contents of which are incorporated herein by reference.

### FIELD

Embodiments described herein generally relate to a printer apparatus, an article management apparatus, and an article management method for an article management apparatus.

### BACKGROUND

There are known an apparatus, a method, and a program that detect a position of a radio frequency identification (RFID) tag via a wireless relay system.

### BRIEF DESCRIPTION OF THE DRAWINGS

FIG. 1 is a block diagram showing a configuration example of an article management apparatus according to an embodiment.

FIG. 2 is a cross-sectional diagram showing a configuration example of the article management apparatus according to the embodiment.

FIG. 3 is a conceptual diagram showing a configuration example of software of the article management apparatus according to the embodiment.

FIG. 4 is an arrangement diagram showing a use example of the article management apparatus according to the embodiment in a store.

FIG. 5 is a table showing an example of a path database (DB) stored in a storage of the article management apparatus according to the embodiment.

FIG. 6 is a diagram showing an example of a setting screen of the article management apparatus according to the embodiment.

FIG. 7 is a table showing an example of setting contents that are set in the article management apparatus according to the embodiment.

FIG. 8 is a diagram showing an example of a standby screen of the article management apparatus according to the embodiment.

FIG. 9 is a flowchart showing the outline of a search operation of the article management apparatus according to the embodiment.

FIG. 10 is a flowchart showing an example of the search operation of the article management apparatus according to the embodiment.

FIG. 11 is a flowchart showing an example of the search operation of the article management apparatus according to the embodiment.

FIG. 12 is a flowchart showing an example of the search operation of the article management apparatus according to the embodiment.

FIG. 13 is a diagram showing an example of a search title input screen of the article management apparatus according to the embodiment.

FIG. 14 is a table showing an example of a search database (DB) that is created by the article management apparatus according to the embodiment.

FIG. 15 is a table showing an example of an inventory database (DB) that is created by the article management apparatus according to the embodiment.

FIG. 16 is a diagram showing an example of a print that is output by the article management apparatus according to the embodiment.

### DETAILED DESCRIPTION

According to one embodiment, a printer apparatus performs a search operation of searching for an article to be searched for and prints a search result of the search operation. The printer apparatus includes a user interface, a tag reader, a wireless communication module, a printing device, and a processor. The user interface is configured to receive an input of search information from a user, the search information being information related to the article to be searched for. The tag reader is configured to receive information from a wireless tag provided to an article located nearby. The wireless communication module is configured to build a mesh network between an own node and a plurality of other external nodes. The printing device is configured to print information on paper. The processor is configured to control the tag reader or the wireless communication module to perform the search operation based on the search information for each node of a communication path of the mesh network from the own node toward a terminal node in the plurality of other external nodes and acquire a search result. In addition, the processor is configured to control the printing device to print the search result for each node of the communication path of the mesh network from the own node toward the terminal node.

Hereinafter, an embodiment will be described with reference to the drawings. For description, constituent elements having substantially the same functions and configurations are denoted by the same reference symbols. In addition, the following embodiment is intended to exemplify the technical idea. The embodiment does not specify the material, shape, structure, arrangement, and the like of the constituent parts. The embodiment can be variously modified.

### Configuration

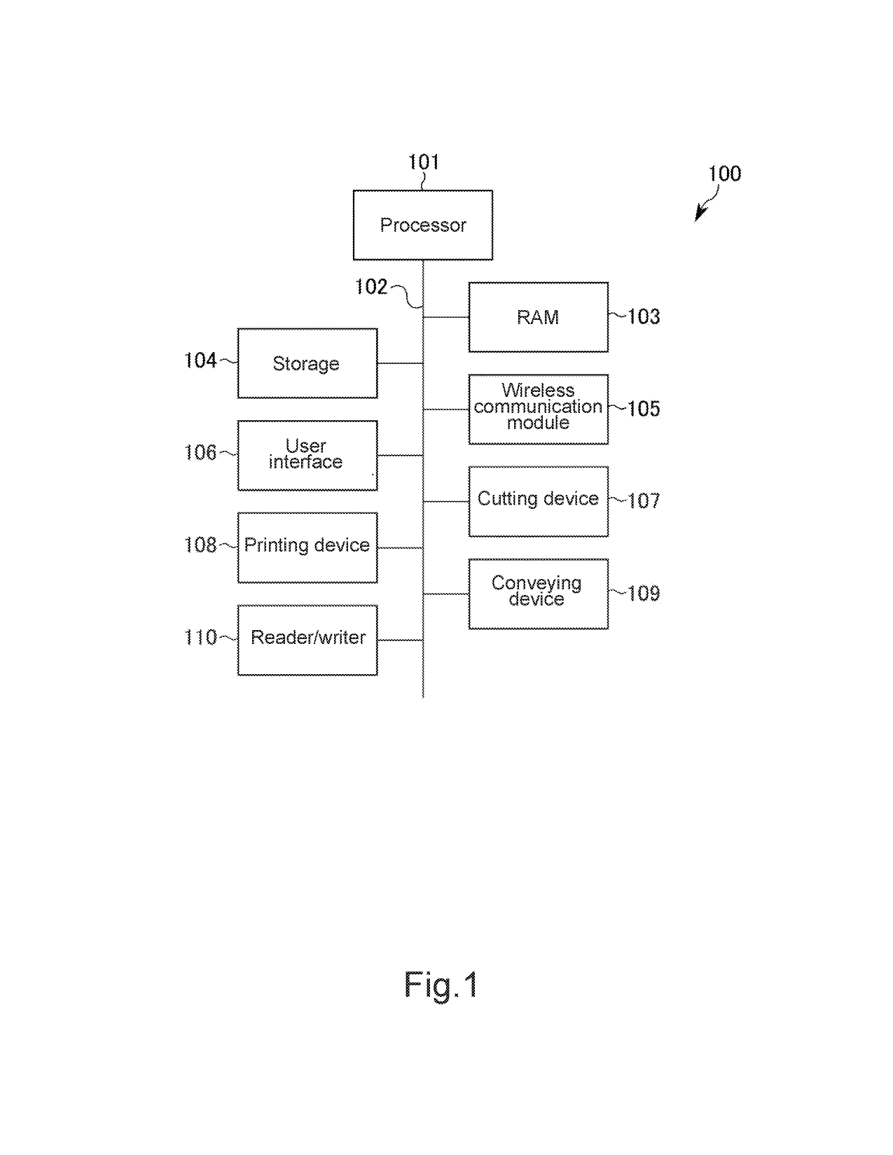

FIG. 1 is a block diagram showing a configuration example of an article management apparatus according to an embodiment. An article management apparatus 100 is an apparatus that manages the inventory status of articles provided with RFID tags, which are one type of wireless tags. In this embodiment, a case where the article management apparatus 100 is a printer apparatus will be described as an example. The article management apparatus 100 includes a processor 101, a bus 102, a random access memory (RAM) 103, a storage 104, a wireless communication module 105, a user interface 106, a cutting device 107, a printing device 108, a conveying device 109, and a reader/writer 110. The bus 102 includes an address bus, a data bus, a control signal line, a power supply line, and the like. The bus 102 connects the processor 101, the RAM 103, the storage 104, the wireless communication module 105, the user interface 106, the cutting device 107, the printing device 108, the conveying device 109, and the reader/writer 110 to one another. The processor 101, the RAM 103, and the storage 104 are connected to one another via the bus 102, so that a computer of the article management apparatus 100 is formed.

The processor 101 corresponds to the central part of the computer described above. The processor 101 controls each part to implement various functions as the article management apparatus 100 according to the operating system and application programs. The processor 101 is, for example, a central processing unit (CPU). The processor 101 may be referred to as, for example, a controller.

The RAM 103 is a volatile storage device. The RAM 103 is used as a work area in which data is rewritten by the processor 101 as appropriate. In addition, the RAM 103 is also used as a buffer memory that temporarily stores data.

The storage 104 is a nonvolatile storage device. The storage 104 corresponds to an auxiliary storage part of the computer. The storage 104 stores the operating system or application programs set in advance, control data, data used by the processor 101 to perform various types of processing, data generated by the processing of the processor 101, and the like. For example, the storage 104 is an electric erasable programmable read-only memory (EEPROM) (registered trademark), a hard disk drive (HDD), a solid state drive (SSD), or the like.

The application programs stored in the storage 104 include a processing program described regarding information processing executed by the article management apparatus 100. The method of installing the processing program in the storage 104 is not particularly limited. The processing program can be installed in the storage 104 by recording the processing program on a removable recording medium or by distributing the processing program through communication via a network. The recording medium can have any form, such as a CD-ROM or a memory card, as long as it can record a program and is computer-readable.

The wireless communication module 105 is a module that performs wireless communication with the outside of the article management apparatus 100. The wireless communication module 105 is, for example, a module compatible with WiFi (registered trademark). The wireless communication module 105 builds a mesh network together with external apparatuses (external nodes) of the article management apparatus 100. The external apparatuses in this embodiment have, for example, the same configuration as that of the article management apparatus 100.

The user interface 106 is a device that presents information to a user of the article management apparatus 100 and receives an input from the user. The user interface 106 is, for example, a touch panel display.

The cutting device 107 cuts printing paper housed in the article management apparatus 100. The cutting device 107 includes, for example, a blade for cutting the paper.

The printing device 108 forms images on the printing paper housed in the article management apparatus 100. The printing device 108 is, for example, a thermal head.

The conveying device 109 conveys the printing paper housed in the article management apparatus 100. The conveying device 109 may also be referred to as, for example, a platen roller.

The reader/writer 110 communicates with an RFID tag. The reader/writer 110 receives information stored in the RFID tag. The reader/writer 110 causes the RFID tag to store information. The reader/writer 110 may also be referred to as, for example, a tag reader.

A set of the cutting device 107, the printing device 108, and the conveying device 109 forms images on the printing paper housed in the article management apparatus 100, and conveys and cuts the printing paper. In other words, the set of the cutting device 107, the printing device 108, and the conveying device 109 outputs information to the outside of the article management apparatus 100. The set of the cutting device 107, the printing device 108, and the conveying device 109 is referred to as, for example, an output unit.

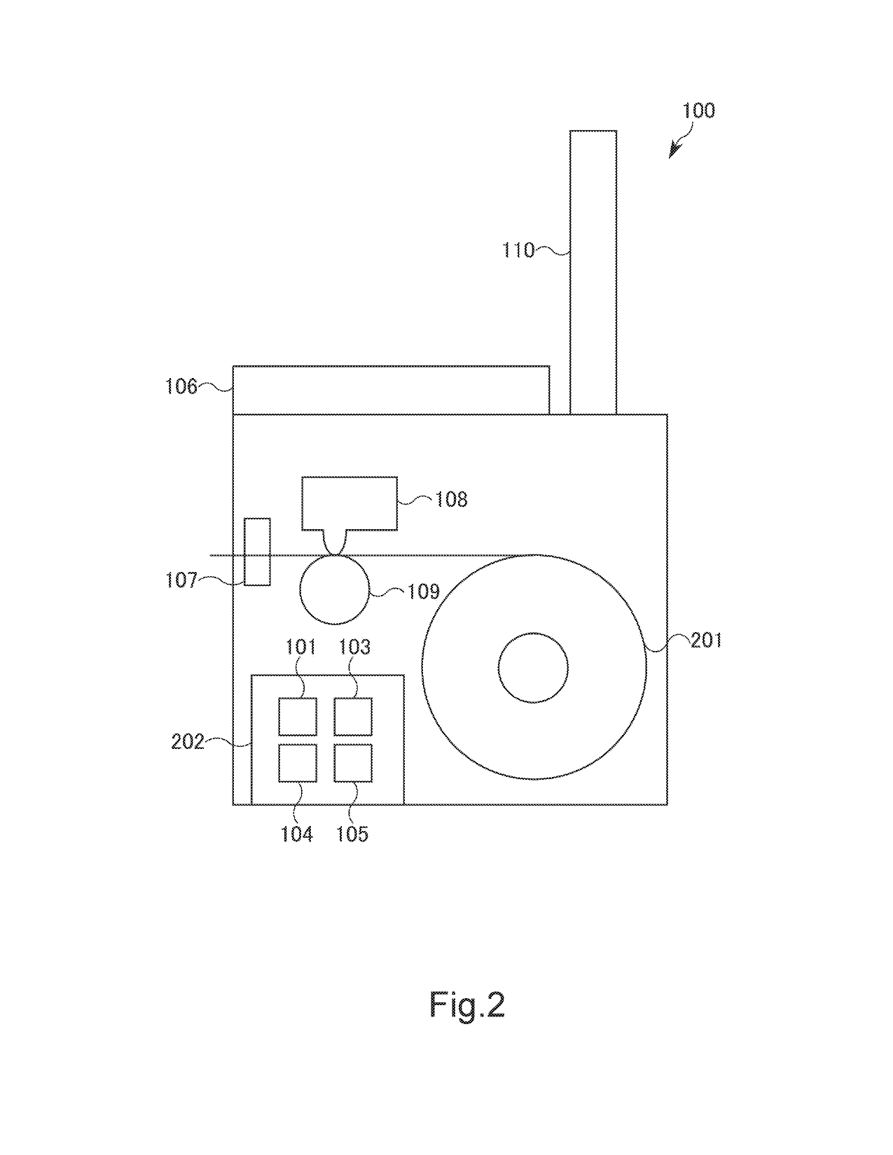

FIG. 2 is a cross-sectional diagram showing a configuration example of the article management apparatus according to the embodiment. The article management apparatus 100 houses printing paper 201. In addition, the article management apparatus 100 further includes a substrate 202.

The substrate 202 is, for example, a printed circuit board. The processor 101, the RAM 103, the storage 104, and the wireless communication module 105 are provided on the substrate 202. The substrate 202 is provided at a stable location within the article management apparatus 100, for example, at the bottom thereof.

The printing paper 201 is, for example, thermal rolled paper that is thermal paper rolled up into a roll form. The printing paper 201 is housed in the article management apparatus 100 and is used by being drawn out from the roll. The printing paper 201 is drawn out from the upstream side of the paper rolled up into the roll form to the downstream side, which is the outside of the article management apparatus 100, by passing in sequence through a point sandwiched between the printing device 108 and the conveying device 109 and a point passing through the cutting device 107.

The printing device 108 and the conveying device 109 are provided to sandwich the printing paper 201 drawn out of the roll. An image is formed at the point at which the printing device 108 and the conveying device 109 sandwich the printing paper 201.

The cutting device 107 is provided such that the printing paper 201 drawn out passes through the interior thereof. The cutting device 107 is provided downstream of the printing device 108 and the conveying device 109.

The user interface 106 is provided at a location that is easy for the user to operate, for example, on the top surface of the article management apparatus 100.

The reader/writer 110 is provided at a location that is easy to communicate with an RFID tag, for example, on the upper part of the article management apparatus 100.

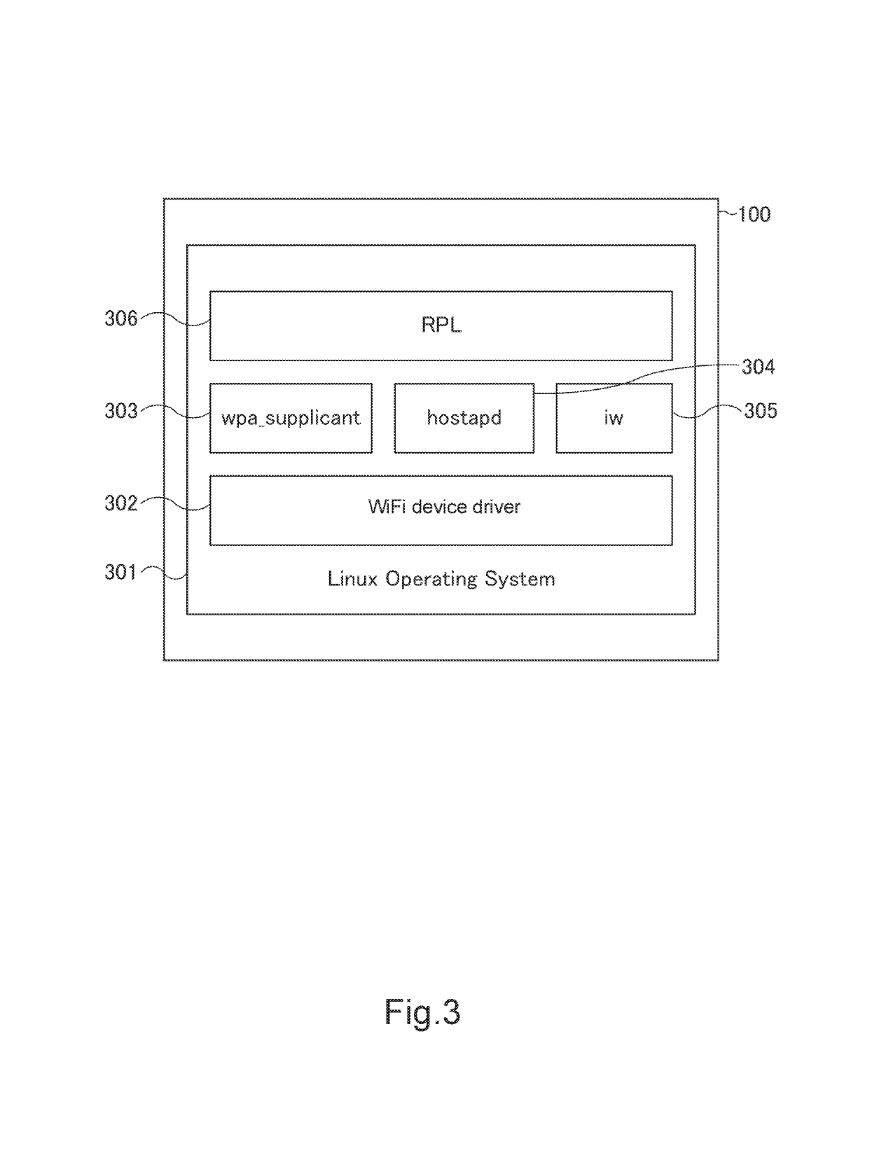

FIG. 3 is a conceptual diagram showing a configuration example of software of the article management apparatus according to the embodiment. The computer of the article management apparatus 100 runs a Linux (registered trademark) Operating System 301. The Linux (registered trademark) Operating System 301 is a system software that manages hardware and software resources of the computer and provides common services to computer programs. A WiFi (registered trademark) device driver 302 runs on the Linux (registered trademark) Operating System 301. The WiFi (registered trademark) device driver 302 is software for the Linux (registered trademark) Operating System 301 to control the wireless communication module 105. In addition, software of wpa_supplicant 303, hostapd 304, and iw 305 run on the Linux (registered trademark) Operating System 301. The wpa_supplicant 303 is software for making a connection request to a wireless local area network (LAN) access point. The hostapd 304 is software for operating the wireless communication module 105 as an access point and authentication server. The iw 305 is software for configuring the wireless LAN network. The communication in the built mesh network is performed according to RPL (IPv6 Routing Protocol for Low-Power and Lossy Networks) 306.

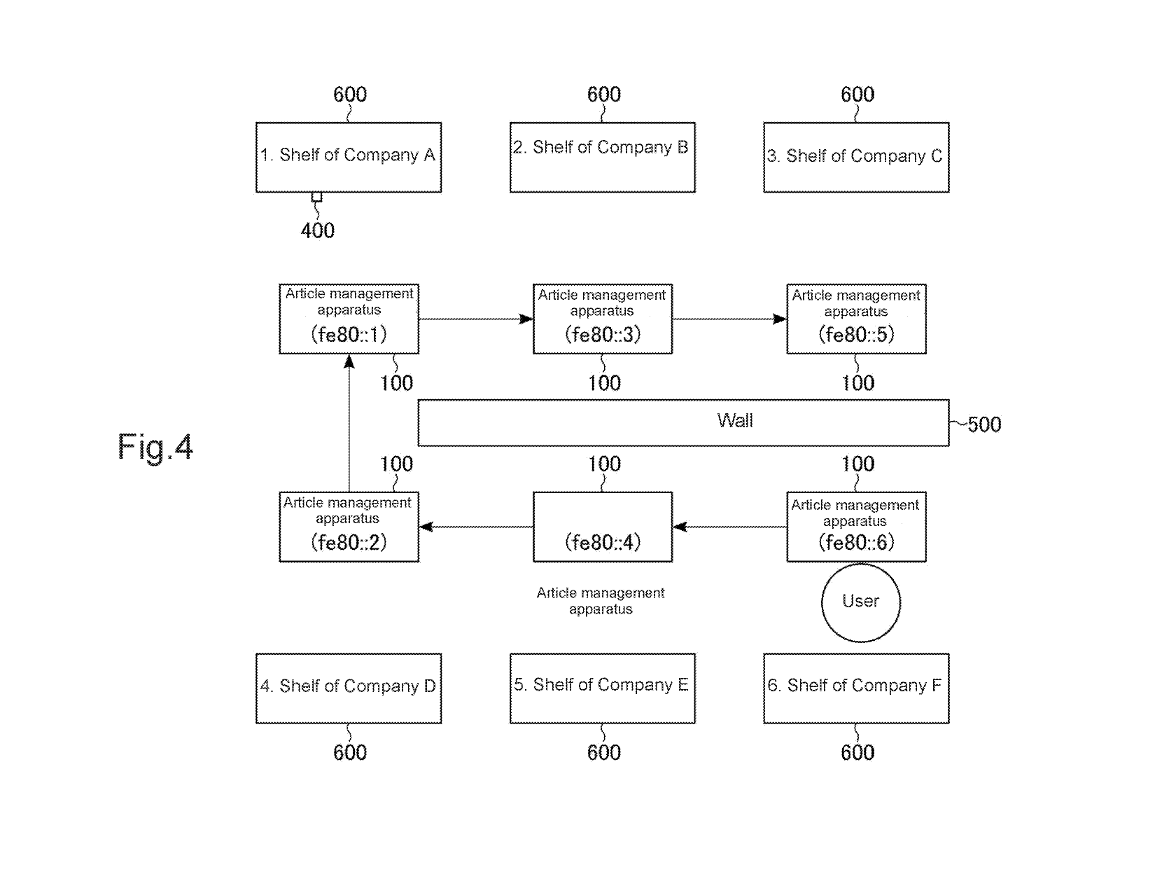

FIG. 4 is an arrangement diagram showing a use example of the article management apparatus according to the embodiment in a store. In this embodiment, a case where six article management apparatuses 100 are disposed in a store such as a bookstore will be described as an example as shown in FIG. 4. Note that the store includes a wall 500. Different addresses are assigned to the respective article management apparatuses 100. In addition, the article management apparatuses 100 are respectively installed in front of different shelves 600. Each of the shelves 600 is given a name. In each of the shelves 600, books provided with RFID tags 400 are stored. In other words, in this embodiment, the articles managed by the article management apparatuses 100 are books. In the example shown in FIG. 4, only one RFID tag 400 is shown and others are omitted.

The six article management apparatuses 100 are disposed to surround the wall 500 in a clockwise direction. An address "fe80::6" is assigned to a first article management apparatus 100. A shelf 600 named "6. Shelf of Company F" is disposed in front of the first article management apparatus 100. Thefirst article management apparatus 100 can communicate with an RFID tag 400 provided to the shelf 600 named "6. Shelf of Company F".

An address "fe80::4" is assigned to a second article management apparatus 100. A shelf 600 named "5. Shelf of Company E" is disposed in front of the second article management apparatus 100. The second article management apparatus 100 can communicate with an RFID tag400 provided to the shelf 600 named "5. Shelf of Company E". The first article management apparatus 100 communicates with the second article management apparatus 100 that constitutes the mesh network.

An address "fe80::2" is assigned to a third article management apparatus 100. A shelf600 named "4. Shelf of Company D" is disposed in front of the third article management apparatus 100. The third article management apparatus 100 can communicate with an RFID tag 400 provided to the shelf 600 named "4. Shelf ofCompany D". The second article management apparatus 100 communicates with the third article management apparatus 100 that constitutes the mesh network.

An address "fe80::1" is assigned to a fourth article management apparatus 100. A shelf600 named "1. Shelf of Company A" is disposed in front of the fourth article management apparatus 100. The fourth article management apparatus 100 can communicate with an RFID tag400 provided to the shelf600 named "1. Shelf of Company A". Thethird article management apparatus 100 communicates with the fourth article management apparatus100 that constitutes the mesh network.

An address "fe80::3" is assigned to a fifth article management apparatus100. A shelf600 named "2. Shelf of Company B" is disposed in front of thefifth article management apparatus100. Thefifth article management apparatus100 can communicate with an RFID tag400 provided to the shelf 600 named "2. Shelf of Company B". The fourth article management apparatus 100 communicates with the fifth article management apparatus100 that constitutes the mesh network.

An address "fe80::5" is assigned to a sixth article management apparatus 100. A shelf 600 named "3. Shelf of Company C" is disposed in front of the sixth article management apparatus 100. The sixth article management apparatus 100 can communicate with an RFID tag 400 provided to the shelf 600 named "3. Shelf of Company C". The fifth article management apparatus 100 communicates with the sixth article management apparatus 100 that constitutes the mesh network.

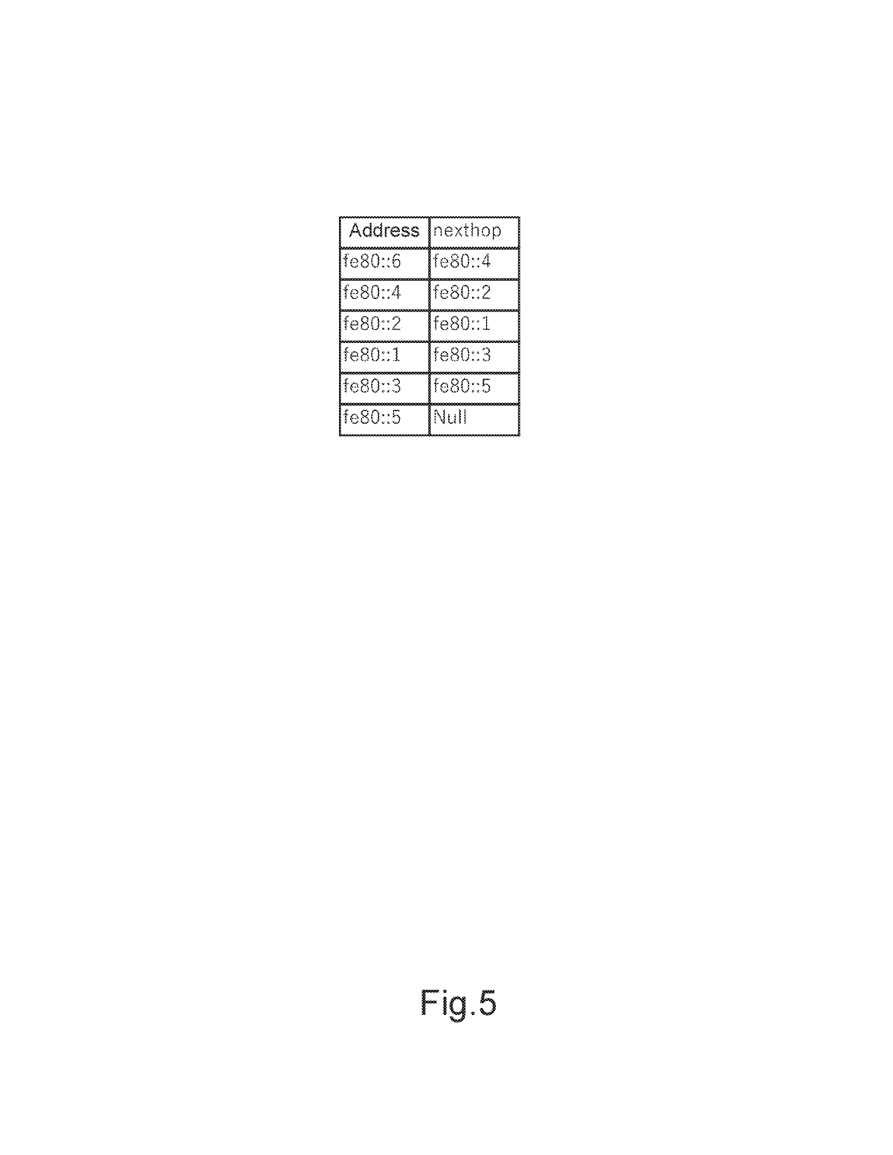

FIG. 5 is a table showing an example of a path database (DB) stored in the storage of the article management apparatus according to the embodiment. The path DB is information related to the path of the mesh network constituted by the plurality of article management apparatuses 100. In the path DB, an address indicating a transmission source address and a nexthop indicating a transmission destination address are described for each address constituting the mesh network. In the example shown in FIG. 5, in the case of the address "fe80::6", the nexthop is "fe80::4". In the case of the address "fe80::4", the nexthop is "fe80::2". In the case of the address "fe80::2", the nexthop is "fe80::1". In the case of the address "fe80::1", the nexthop is "fe80::3". In the case of the address "fe80::3", the nexthop is "fe80::5". In the case of the address "fe80::5", the nexthop is "Null".

### Operation

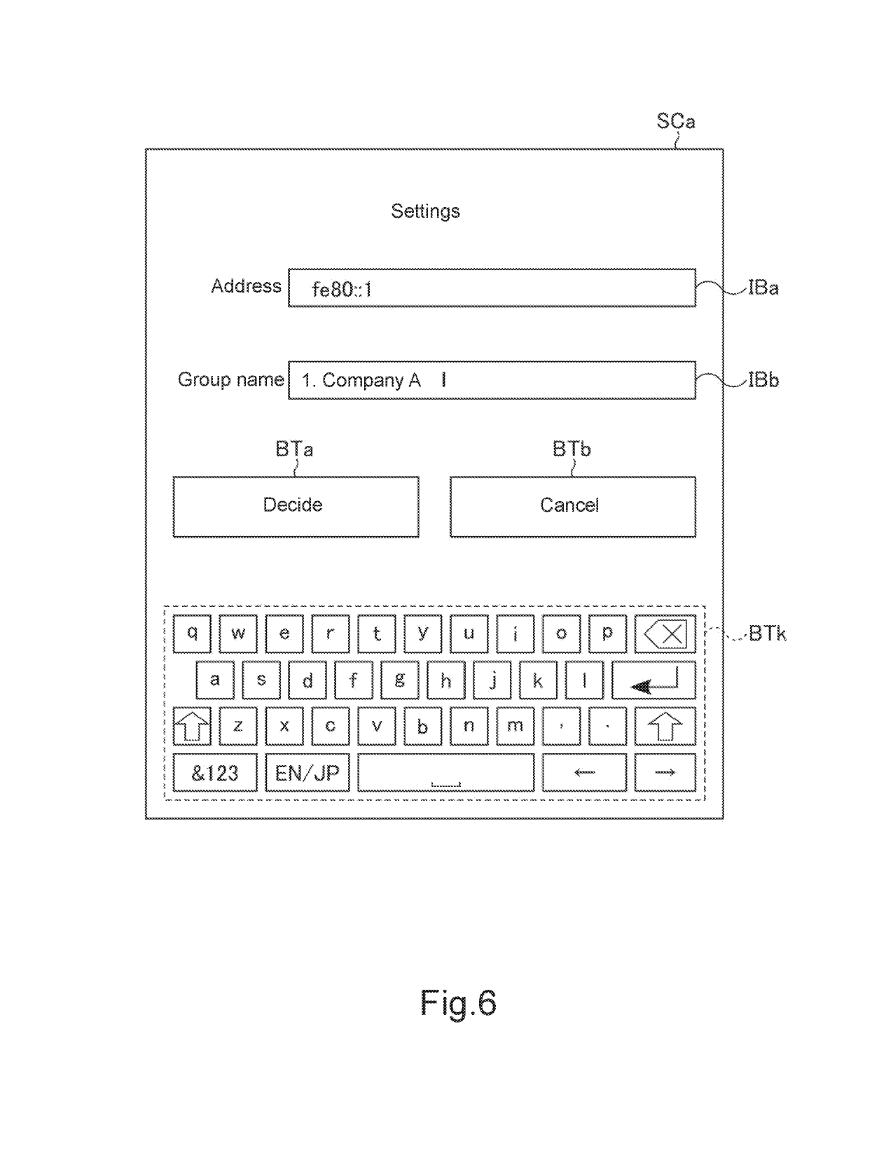

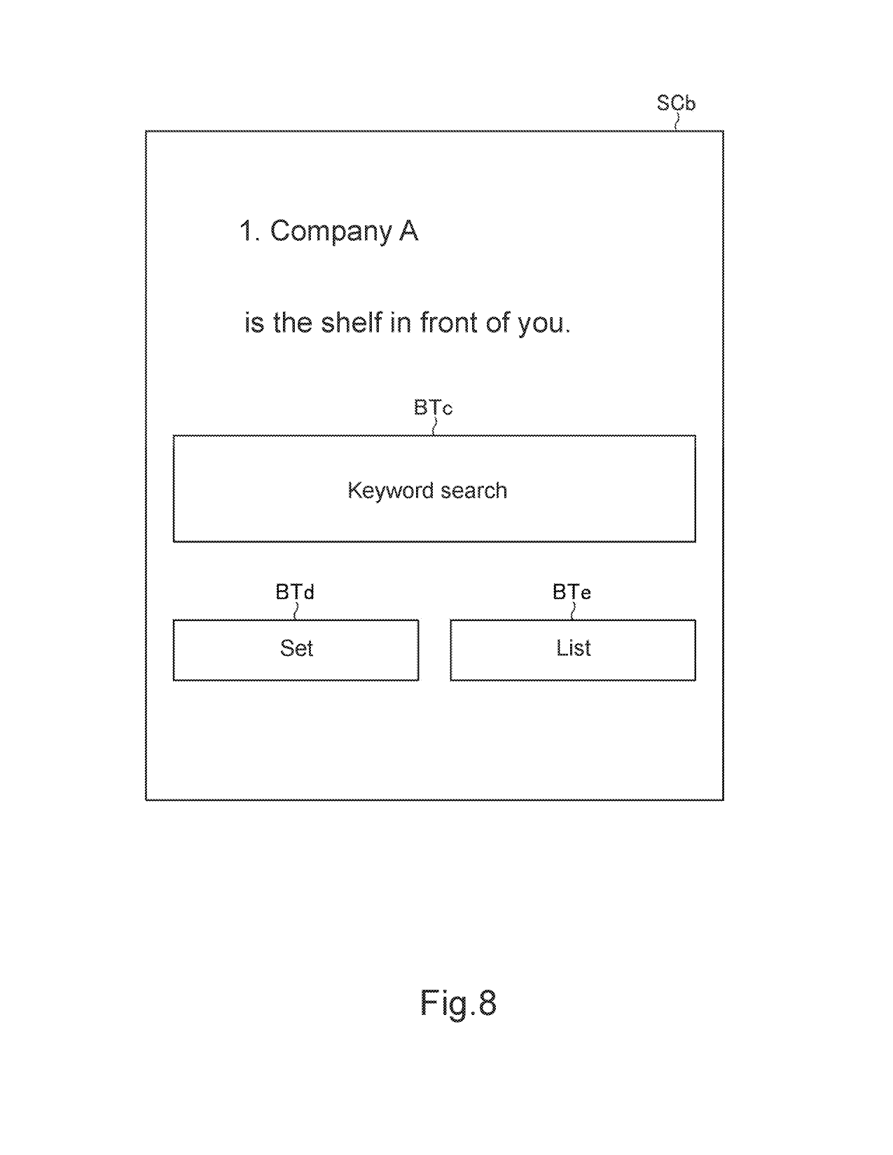

A setting operation of the article management apparatus 100 according to the embodiment will be described. The setting operation is an operation of setting the information to be used when a plurality of article management apparatuses 100 are used in combination. FIG. 6 is a diagram showing an example of a setting screen of the article management apparatus according to the embodiment. When the user operates the user interface 106 to select "set" from a standby screen to be described later (see FIG. 8), the screen displayed on the user interface 106 transitions to a setting screen SCa shown in FIG. 6. The setting screen SCa shows an example displayed in the fourth article management apparatus 100 described with reference to FIG. 4. On the setting screen SCa, an input box IBa for inputting an address, an input box IBb for inputting a group name, a decision button BTa for deciding input contents, a cancel button BTb for cancelling the input contents, and a keyboard button BTk for inputting text are displayed. The user selects the input box IBa or IBb and operates the keyboard button BTk to input setting contents. Upon completion of the input to the input boxes IBa and IBb, the user operates the decision button BTa to decide the setting contents.

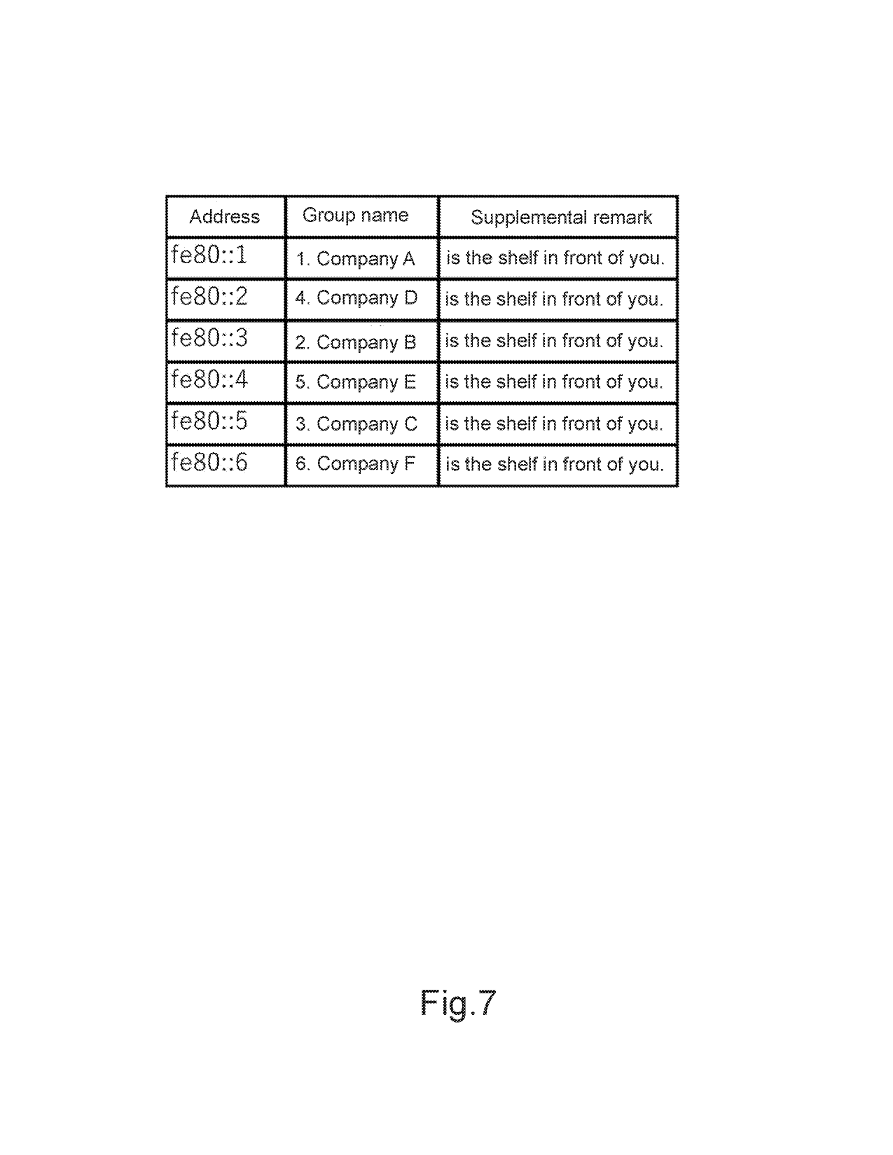

FIG. 7 is a table showing an example of setting contents that are set in the article management apparatus according to the embodiment. FIG. 7 shows the address, group name, and supplemental remark that are set for each address. In the case of the address "fe80::1", the group name is "1. Company A". In the case of the address "fe80::2", the group name is "4. Company D". In the case of the address "fe80::3", the group name is "2. Company B". In the case of the address "fe80::4", the group name is "5. Company E". In the case of the address "fe80::5", the group name is "3. Company C". In the case of the address "fe80::6", the group name is "6. Company F". The supplemental remark is "… is the shelf in front of you.", which is common to all addresses.

A standby operation of the article management apparatus 100 according to the embodiment will be described. The standby operation is an operation when the article management apparatus 100 is waiting for a user operation. FIG. 8 is a diagram showing an example of a standby screen of the article management apparatus according to the embodiment. A standby screen SCb is displayed on the user interface 106. In the upper part of the standby screen SCb, the group name and supplemental remark that have been set on the setting screen described above are displayed. In the center part of the standby screen SCb, a keyword search button BTc for starting a search operation is displayed. In the lower part of the standby screen SCb, a set button BTd for staring the setting operation described above and a list button BTe for displaying the list of inventory held by the article management apparatus 100 are displayed.

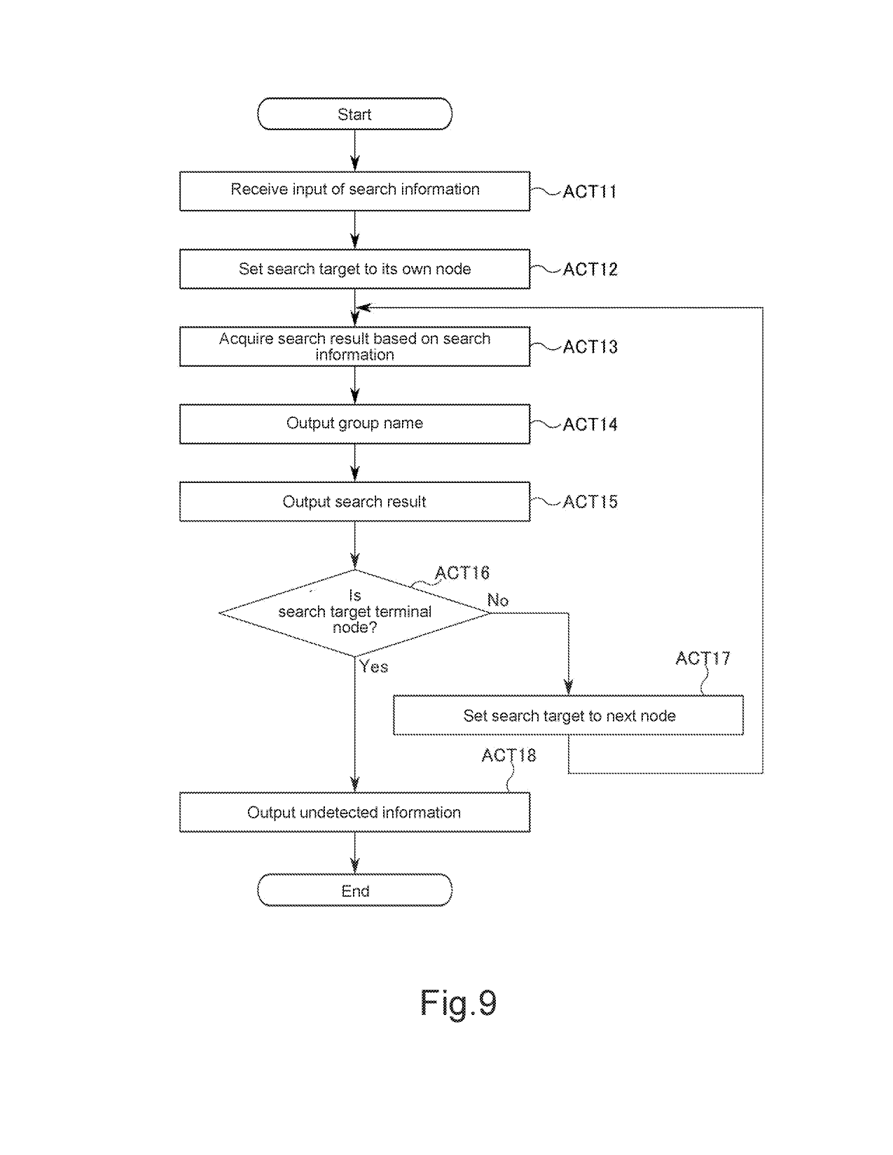

The outline of the search operation of the article management apparatus 100 according to the embodiment will be described. The search operation is an operation of searching for the location of an article and outputting a result on the basis of the input of the user. In this embodiment, a case where a user operates the first article management apparatus 100 in the arrangement described with reference to FIG. 4 will be described as an example. FIG. 9 is a flowchart showing the outline of the search operation of the article management apparatus according to the embodiment. When the search operation is started, the article management apparatus 100 receives an input of search information (ACT11). Specifically, the processor 101 of the article management apparatus 100 controls the user interface 106 to receive an input of search information by the user.

The article management apparatus 100 sets a search target apparatus (article management apparatus) to its own node (its own apparatus) (ACT12). Specifically, the processor 101 sets its own node, in the mesh network constituted by the article management apparatus 100, as a target to be subjected to search processing.

The article management apparatus 100 acquires a search result based on the search information (ACT13). Specifically, if an apparatus to be subjected to search processing (article management apparatus) is its own node, the processor 101 controls the reader/writer 110 to communicate with the RFID tag 400 and updates inventory information. The processor 101 then acquires a search result on the basis of the updated inventory information and the search information. Meanwhile, if an apparatus to be subjected to search processing is not its own node, the processor 101 controls the wireless communication module 105 to communicate with an apparatus to be subjected to search processing. In this communication, the processor 101 instructs a node to be subjected to search processing (another article management apparatus) to update the inventory information and transmit the inventory information and the group name thereto. The processor 101 acquires a search result on the basis of the inventory information and the search information received by the wireless communication module 105.

The article management apparatus 100 outputs the group name (ACT14). Specifically, the processor 101 controls the printing device 108 and the conveying device 109 to print on the printing paper 201 the group name of the apparatus to be subjected to search processing (article management apparatus).

The article management apparatus 100 outputs the search result (ACT15). Specifically, the processor 101 controls the printing device 108 and the conveying device 109 to print on the printing paper 201 the search result acquired in ACT13.

The article management apparatus 100 determines whether or not the search target is a terminal node (ACT16). If the search target is not a terminal node (ACT16, No), the article management apparatus 100 sets the search target to the next node (ACT17). Specifically, the processor 101 sets the search target to the next node with reference to the path DB. The article management apparatus 100 then executes the processing of ACT13. In other words, the article management apparatus 100 repeats the processing from ACT13 to ACT15 while setting the search target to the next node.

In ACT16, if the search target is a terminal node (ACT16, Yes), the article management apparatus 100 outputs undetected information (ACT18). Specifically, the processor 101 outputs, as undetected information, items that have not been output as search results in the search information. More specifically, the processor 101 controls the printing device 108 and the conveying device 109 to print undetected information on the printing paper 201. Upon completion of printing, the processor 101 controls the cutting device 107 to cut the printing paper 201.

Upon completion of the processing of ACT18, the series of processing shown in FIG. 9 is terminated.

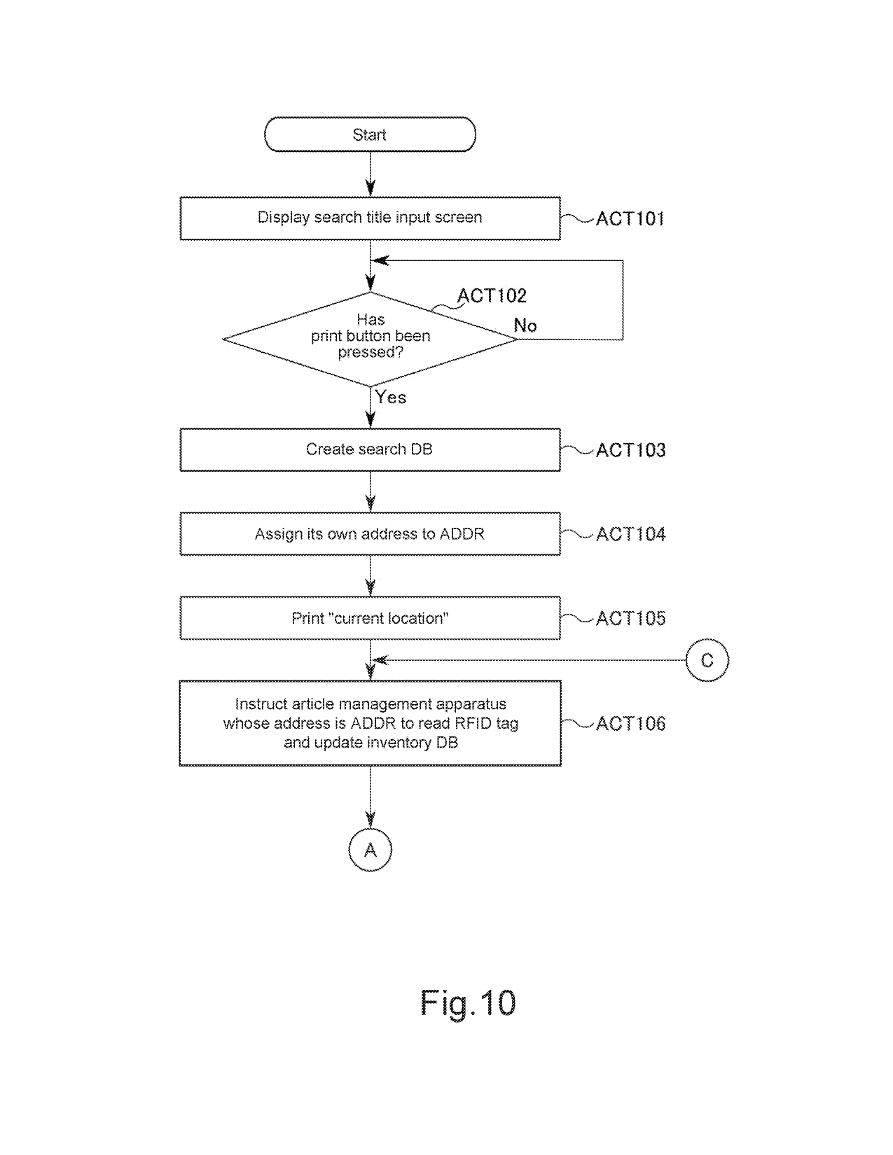

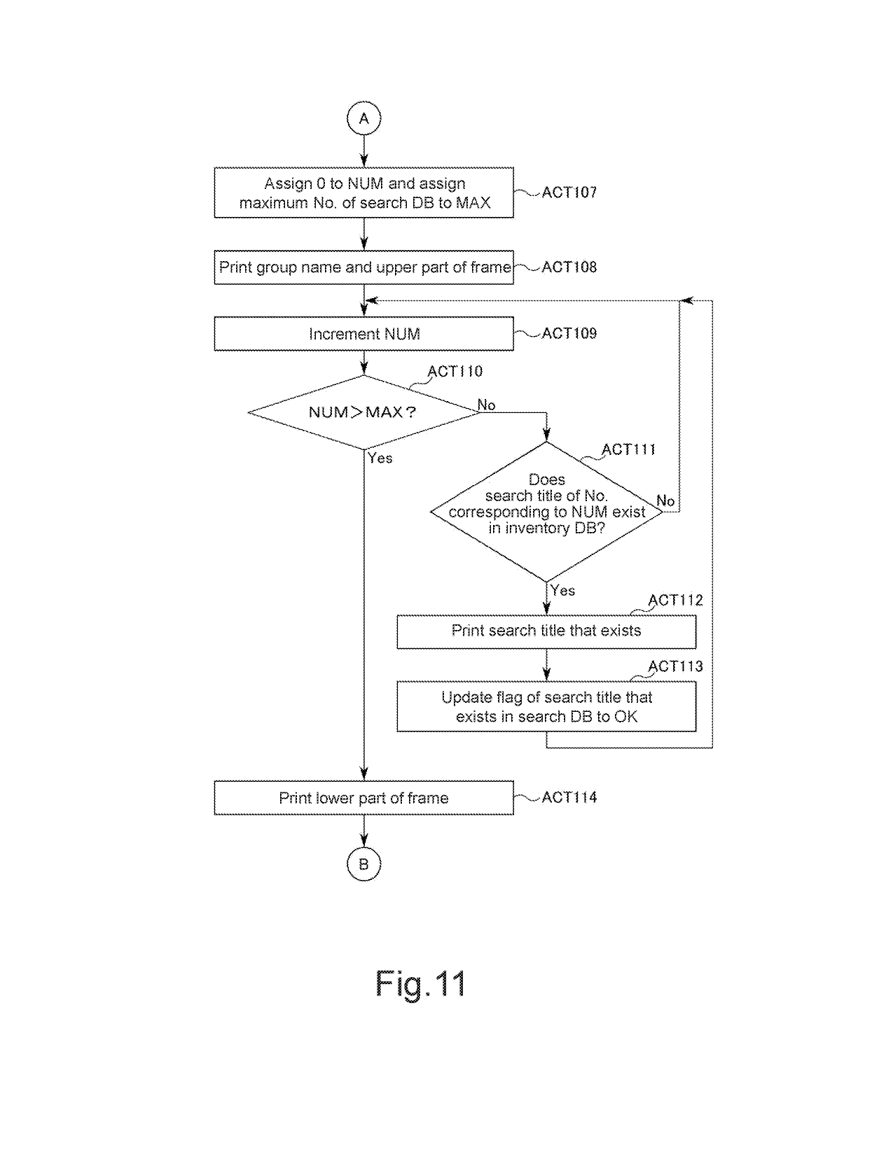

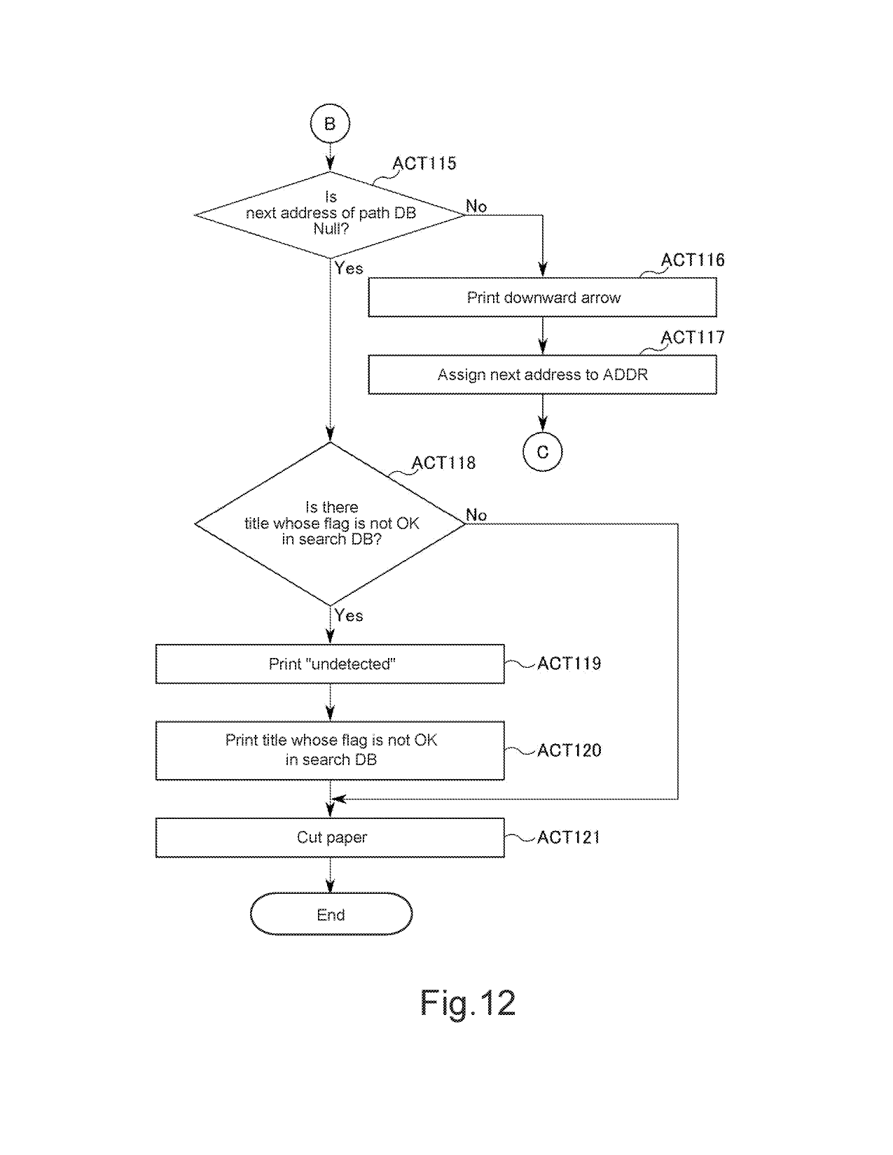

More specific examples will be described for the search operation of the article management apparatus 100 according to the embodiment. FIGS. 10 to 12 are flowcharts each showing an example of the search operation of the article management apparatus according to the embodiment. When the search operation is started, the article management apparatus 100 displays a search title input screen (ACT101). Specifically, the processor 101 of the article management apparatus 100 controls the user interface 106 to display a search title input screen.

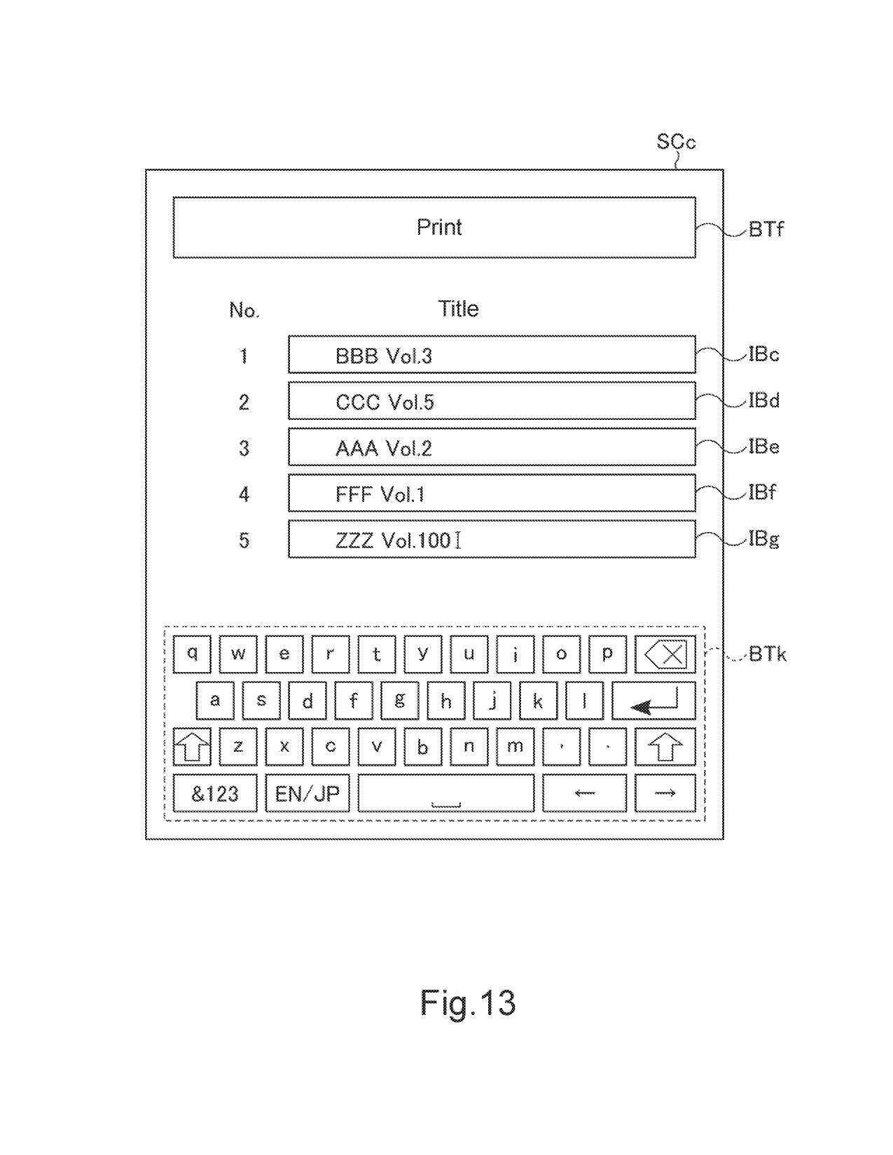

FIG. 13 is a diagram showing an example of the search title input screen of the article management apparatus according to the embodiment. A search title input screen SCc is displayed on the user interface 106. In the upper part of the search title input screen SCc, a print button BTf for starting printing is displayed. In the center part of the search title input screen SCc, input boxes IBc, IBd, IBe, IBf, and IBg for inputting a serial number (No.) and a title of a book to be searched for are displayed. In the lower part of the search title input screen SCc, a keyboard button BTk for inputting text is displayed. The user selects an input box in order from the input boxes with the smaller serial numbers and operates the keyboard button BTk to input a title to be searched for. When completing the input of the title to be searched for, the user operates the print button BTf.

Return to the description with reference to FIGS. 10 to 12. The article management apparatus 100 determines whether or not the print button has been pressed (ACT102). If the print button BTf has not been pressed (ACT102, No), the article management apparatus 100 waits while repeating ACT102 until the print button BTf is pressed.

If the print button BTf has been pressed in ACT102 (ACT102, Yes), the article management apparatus 100 creates a search database (DB) (ACT103). Specifically, the processor 101 controls the RAM 103 to create a search DB on the RAM 103.

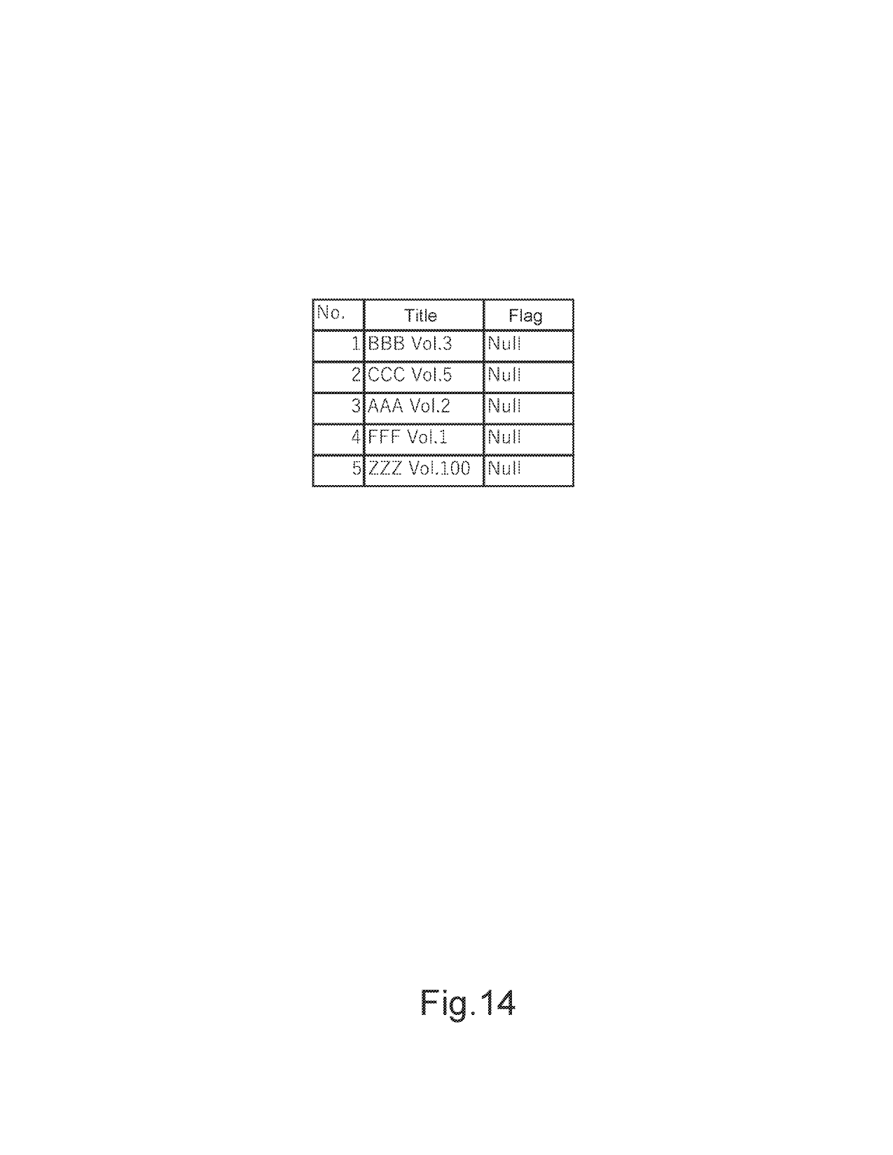

FIG. 14 is a table showing an example of a search DB created by the article management apparatus according to the embodiment. FIG. 14 shows an example of the search DB created on the basis of the example shown in FIG. 13. As shown in FIG. 14, the search DB includes a serial number (No.), a title, and a flag. The serial number and the title correspond to the contents displayed on and input to the search title input screen SCc shown in FIG. 13. The flag is a parameter for determining whether or not the item has been output as a search result in the search operation. In the example shown in FIG. 14, in the serial number 1, the title is "BBB Vol.3". In the serial number 2, the title is "CCC Vol.5". In the serial number 3, the title is "AAA Vol.2". In the serial number 4, the title is "FFF Vol.1". In the serial number 5, the title is "ZZZ Vol.100". In the example shown in FIG. 14, all flags are "Null".

Return to the description with reference to FIGS. 10 to 12. The article management apparatus 100 assigns its own address to a variable ADDR (ACT104). Specifically, the processor 101 assigns the address of the article management apparatus 100, for which the print button BTf has been pressed, to the variable ADDR.

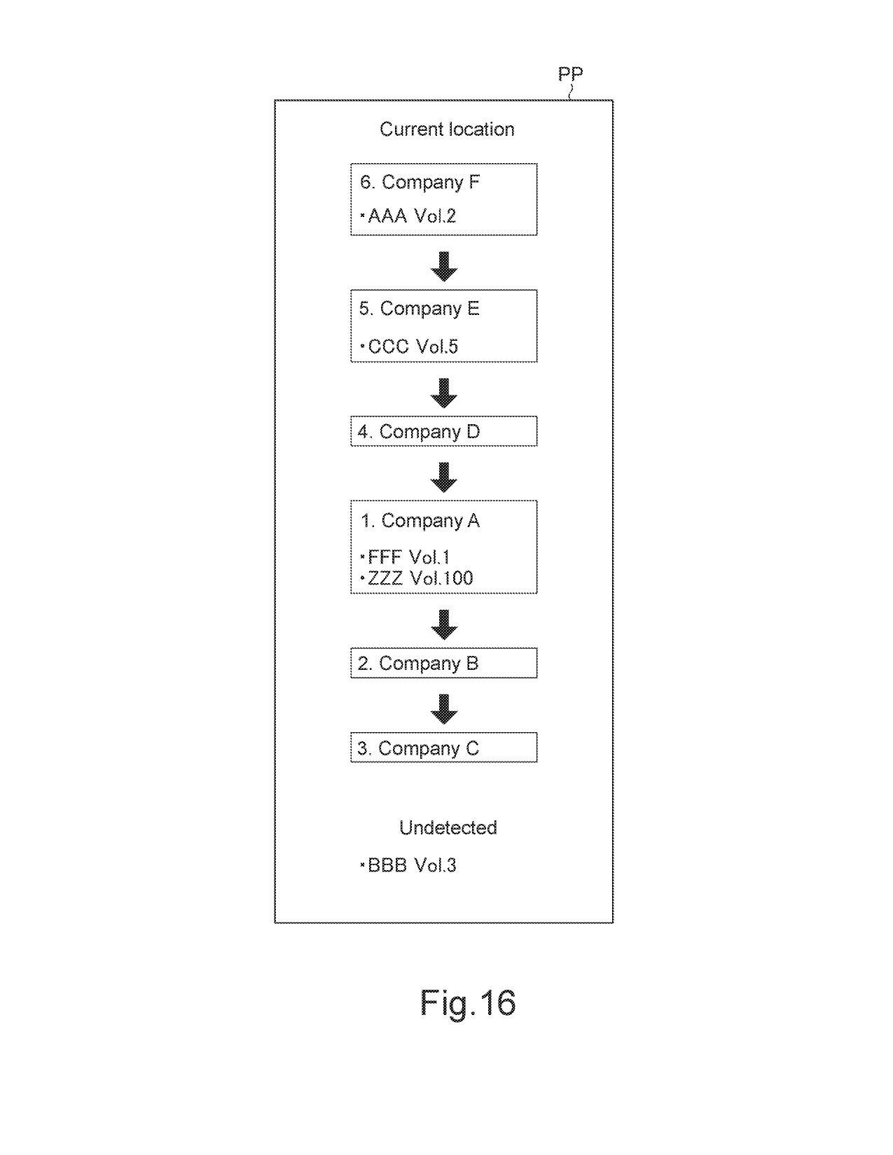

The article management apparatus 100 prints a "current location" (ACT105). Specifically, the processor 101 controls the printing device 108 and the conveying device 109 to print a character string, "current location", on the printing paper 201 (see FIG. 16).

The article management apparatus 100 instructs the article management apparatus whose address is ADDR to read an RFID tag and update the inventory DB (ACT106). Specifically, the processor 101 instructs the article management apparatus 100 whose address is stored in the variable ADDR to read an RFID tag 400 and update the inventory database (DB).

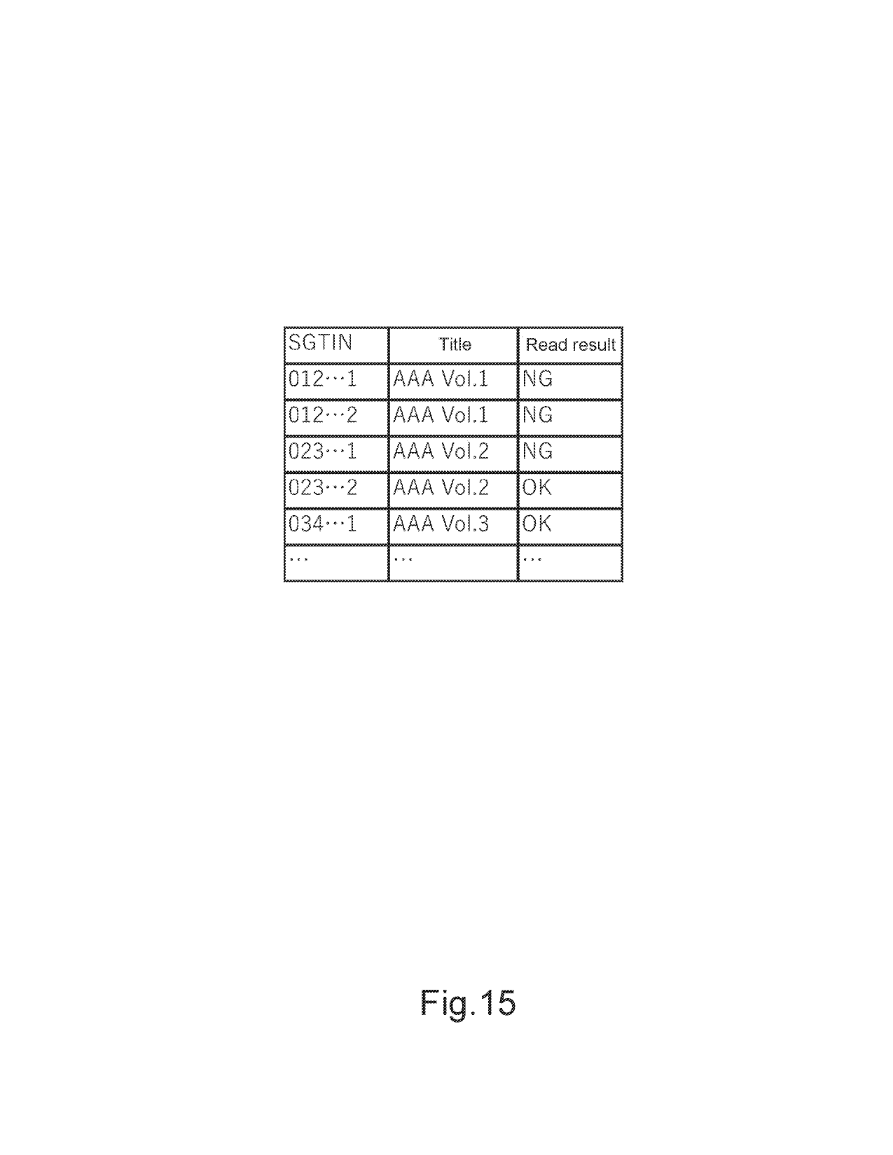

FIG. 15 is a table showing an example of the inventory DB created by the article management apparatus according to the embodiment. As shown in FIG. 15, the inventory DB includes a serialized global trade item number (SGTIN), a title, and a read result. The SGTIN is a product identification code provided with a serial number. The title is a title of a book associated with the SGTIN. The read result is a parameter indicating whether or not the reader/writer 110 has been able to read an appropriate RFID tag 400. In the example shown in FIG. 15, an item in which the SGTIN is "012…1", the title is "AAA Vol.1", and the read result is "NG" is described. An item in which the SGTIN is "012…2", the title is "AAA Vol.1", and the read result is "NG" is described. An item in which the SGTIN is "023…1", the title is "AAA Vol.2", and the read result is "NG" is described. An item in which the SGTIN is "023…2", the title is "AAA Vol.2", and the read result is "OK" is described. An item in which the SGTIN is "034…1", the title is "AAA Vol.3", and the read result is "OK" is described.

Return to the description with reference to FIGS. 10 to 12. The article management apparatus 100 assigns 0 to NUM, and assigns the maximum No. of the search DB to MAX (ACT107). Specifically, the processor 101 assigns 0 to the variable NUM and assigns the maximum value of the serial number of the search DB (see FIG. 14) to the variable MAX.

The article management apparatus 100 prints the group name and the upper part of the frame (ACT108). Specifically, the processor 101 controls the printing device 108 and the conveying device 109 to print the group name (e.g., "6. Company F") and the upper part of the frame on the printing paper 201 (see FIG. 16 to be described later).

The article management apparatus 100 increments the NUM (ACT109). Specifically, the processor 101 increments the variable NUM.

The article management apparatus 100 determines whether or not the NUM is larger than the MAX (ACT110). If the variable NUM is not larger than the variable MAX (ACT110, No), the article management apparatus 100 determines whether or not a search title (see FIG. 14) of the number corresponding to the NUM exists in the inventory DB (see FIG. 15) (ACT111). If the search title of the serial number corresponding to the variable NUM does not exist in the inventory DB (ACT111, No), the article management apparatus 100 executes ACT109.

In ACT111, if the search title (see FIG. 14) of the serial number corresponding to the variable NUM exists in the inventory DB (see FIG. 15) (ACT111, Yes), the article management apparatus 100 prints the search title that exists (ACT112). Specifically, the processor 101 controls the printing device 108 and the conveying device 109 to print the search title that exists (e.g., "AAA Vol.2") on the printing paper 201 (see FIG. 16 to be described later). Subsequently, the article management apparatus 100 updates the flag of the search title that exists in the search DB (see FIG. 14) to OK (ACT113). The article management apparatus 100 then executes ACT109.

In such a manner, the article management apparatus 100 repeats the operation from ACT109 to ACT113 until the variable NUM becomes larger than the variable MAX. In other words, the article management apparatus 100 determines whether or not the search titles (see FIG. 14) exist in the inventory DB (see FIG. 15) in sequence from the serial number of 1 to the maximum value, and if the search title exists, executes the printing and the update of the flag.

In ACT110, if the variable NUM is larger than the variable MAX (ACT110, Yes), the article management apparatus 100 prints the lower part of the frame (ACT114). Specifically, the processor 101 controls the printing device 108 and the conveying device 109 to print the lower part of the frame on the printing paper 201 (see FIG. 16 to be described later).

The article management apparatus 100 determines whether or not the next address of the path DB is Null (ACT115). If the next address of the path DB (see FIG. 5) is not Null (ACT115, No), the article management apparatus 100 prints a downward arrow (ACT116). Specifically, the processor 101 controls the printing device 108 and the conveying device 109 to print a downward arrow on the printing paper 201 (see FIG. 16 to be described later). Subsequently, the article management apparatus 100 assigns the next address to the ADDR (ACT117). Specifically, the processor 101 assigns the next address shown in the path DB to the variable ADDR. The article management apparatus 100 then executes the processing of ACT106.

In such a manner, the article management apparatus 100 repeats the operation of ACT106 to ACT117 until the next address of the path DB becomes Null. In other words, the article management apparatus 100 updates the inventory DB, determines whether or not a search title exists, and performs printing in sequence from its own node to the terminal node.

In ACT115, if the next address of the path DB (see FIG. 5) is Null (ACT115, Yes), the article management apparatus 100 determines whether there is a title whose flag is not OK in the search DB (see FIG. 14) (ACT118). If there is a title whose flag is not OK in the search DB (ACT118, Yes), the article management apparatus 100 prints "undetected" (ACT119). Specifically, the processor 101 controls the printing device 108 and the conveying device 109 to print a character string, "undetected", on the printing paper 201 (see FIG. 16 to be described later). Subsequently, the article management apparatus 100 prints a title whose flag is not OK (e.g., "BBB Vol.3") (ACT120).

In ACT118, if there is no title whose flag is not OK in the search DB (ACT118, No), and if the processing of ACT120 is completed, the article management apparatus 100 cuts the paper (ACT121). Specifically, the processor 101 controls the cutting device 107 to cut the printing paper 201.

Upon completion of the processing of ACT121, the series of processing shown in FIGS. 10 to 12 is terminated.

FIG. 16 is a diagram showing an example of a print that is output by the article management apparatus according to the embodiment. A print PP shown in FIG. 16 is output by the series of processing shown in FIGS. 10 to 12. As shown in FIG. 16, the "current location" printed by the processing of ACT105 is described in the upper part of the print PP. Below the "current location", the upper part of the frame printed by the processing of ACT108 is described, and below it, the group name "6. Company F" is described. Below the group name, "AAA Vol.2" printed by the processing of ACT112 is described. Below it, the lower part of the frame printed by the processing of ACT114 is described, and a downward arrow printed by the processing of ACT116 is described. Below it, each group name and each search title that exists are described by repeating the processing of ACT106 to ACT117. In the lower part of the print PP, "undetected" printed by the processing of ACT119 is described. Below it, "BBB Vol.3" printed by the processing of ACT120 is described.

For the outline of the search operation shown in FIG. 9 and the specific example of the search operation shown in FIGS. 10 to 12, a correspondence relationship is complementally described. ACT11 described with reference to FIG. 9 corresponds to ACT101 to ACT103 described with reference to FIGS. 10 to 12. The "search information" in ACT11 corresponds to the "search title" (e.g., title of book) and the "search DB" in ACT101 to ACT103. ACT12 described with reference to FIG. 9 corresponds to ACT104 described with reference to FIGS. 10 to 12. The variable indicating the "search target" in ACT12 corresponds to the variable ADDR in ACT104. ACT13 described with reference to FIG. 9 corresponds to ACT106 described with reference to FIGS. 10 to 12. The "search result" in ACT13 corresponds to the "inventory DB" in ACT106. ACT14 described with reference to FIG. 9 corresponds to ACT108 described with reference to FIGS. 10 to 12. The output of the group name in ACT14 corresponds to printing of the group name in ACT108. ACT15 described with reference to FIG. 9 corresponds to ACT109 to ACT113 described with reference to FIGS. 10 to 12. The output of the search result in ACT15 corresponds to printing of the search title that exists in ACT112. ACT16 described with reference to FIG. 9 corresponds to ACT115 described with reference to FIGS. 10 to 12. The terminal node in ACT16 corresponds to the fact that "the next address of the path DB is Null" in ACT115. ACT17 described with reference to FIG. 9 corresponds to ACT117 described with reference to FIGS. 10 to 12. "Set to the next node" in ACT17 corresponds to "assign the next address to ADDR" in ACT117. ACT18 described with reference to FIG. 9 corresponds to ACT118 to ACT120 described with reference to FIGS. 10 to 12. The "undetected information" in ACT18 corresponds to "the title whose flag is not OK in the search DB" in ACT120.

### Effects

There is a limit to the distance at which a reader/writer can detect an RFID tag. Therefore, for example, in order to read RFID tags distributed in a large space, it is conceivable to provide a plurality of readers/writers. Aggregating the results detected by the plurality of readers/writers makes it possible to know the presence of RFID tags in the entire large space.

According to the embodiment, the article management apparatus 100 includes the user interface 106 that receives an input of search information from a user. The article management apparatus 100 includes the wireless communication module 105 that builds a mesh network together with a plurality of external apparatuses. The article management apparatus 100 includes the reader/writer 110 that receives information from a RFID tag 400 located nearby. The article management apparatus 100 includes the printing device 108 that prints information on paper. The article management apparatus 100 includes the processor 101 that controls the reader/writer 110 or the wireless communication module 105 to acquire a search result based on search information and controls the printing device 108 to print the search result, for each node of the communication path of the mesh network from its own node to a terminal node. Thus, in the article management apparatus 100 according to the embodiment, the search results investigated for distant RFID tags 400, which cannot be detected from the article management apparatus 100 operated by the user, can be printed from the article management apparatus 100 operated by the user. Therefore, the user can obtain search results by only operating the nearest article management apparatus 100 without walking around in a large space.

In addition, according to the embodiment, the processor 101 of the article management apparatus 100 controls the printing device 108 to print search results in the order of the communication path from its own node toward the terminal node. In such a manner, the article management apparatus 100 according to the embodiment can show the user the route to retrieve the articles along the communication path. Thus, the user can retrieve a desired article without walking unnecessary distances.

In addition, according to the embodiment, the processor 101 of the article management apparatus 100 controls the printing device 108 to further print the undetected information that is not contained in any search results of the search information. Thus, the article management apparatus 100 according to the embodiment can notify the user of search targets that are not contained in the inventory.

In addition, according to the embodiment, the processor 101 of the article management apparatus 100 controls the printing device 108 to print the group name associated with each apparatus, together with the search results. Thus, the article management apparatus 100 according to the embodiment can inform the user of the search results more clearly.

### Other Modifications Etc.

In the embodiment described above, the case where the article management apparatus 100 includes the cutting device 107, the printing device 108, and the conveying device 109, and an image is formed on the printing paper 201 to output information, that is, the case where the article management apparatus 100 is a printer apparatus has been described as an example. The article management apparatus 100 is not limited to the printer apparatus, and a configuration different from that including the cutting device 107, the printing device 108, and the conveying device 109 may be used as an output unit. For example, the user interface 106 may be used as an output unit. Specifically, the processor 101 controls the user interface 106 to display a search result on the display, for example, or to display a two-dimensional bar code to allow access to the search result on the display, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer apparatus that performs a search operation of searching for an article to be searched for and prints a search result of the search operation, the printer apparatus comprising:
a user interface configured to receive an input of search information from a user, the search information being information related to the article to be searched for;
a tag reader configured to receive information from a wireless tag provided to an article located nearby;
a wireless communication module configured to build a mesh network between an own node and a plurality of other external nodes;
a printing device configured to print information on paper; and
a processor configured to
control the tag reader or the wireless communication module to perform the search operation based on the search information for each node of a communication path of the mesh network from the own node toward a terminal node in the plurality of other external nodes and acquire a search result, and
control the printing device to print the search result for each node of the communication path of the mesh network from the own node toward the terminal node.

2. The printer apparatus according to claim 1, wherein
the processor controls the printing device to print the search result in an order of the communication path from the own node toward the terminal node.

3. The printer apparatus according to claim 1, wherein
the processor controls the printing device to further print undetected information that is not contained in the search result in the search information.

4. The printer apparatus according to claim 1, wherein
the processor controls the printing device to print a group name associated with an apparatus of each of the nodes, together with the search result.

5. An article management apparatus that performs a search operation of searching for an article to be searched for and outputs a search result of the search operation, the article management apparatus comprising:
a user interface configured to receive an input of search information from a user, the search information being information related to the article to be searched for;
a tag reader configured to receive information from a wireless tag provided to an article located nearby;
a wireless communication module configured to build a mesh network between an own node and a plurality of other external nodes;
an output device configured to output information to an outside; and
a processor configured to
control the tag reader or the wireless communication module to perform the search operation based on the search information for each node of a communication path of the mesh network from the own node toward a terminal node in the plurality of other external nodes and acquire a search result, and
control the output device to output the search result for each node of the communication path of the mesh network from the own node toward the terminal node.

6. The article management apparatus according to claim 5, wherein
the processor first sets, when the search information is input with the user interface, the node to be searched for as the own node and performs the search operation for the own node.

7. The article management apparatus according to claim 6, wherein
the processor sets, after performing the search operation for the own node, the node to be searched for as a next node in an order of the communication path from the own node toward the terminal node and performs the search operation for the next node.

8. The article management apparatus according to claim 6, wherein
the processor controls, when setting the node to be searched for as the own node, the tag reader to acquire the search result.

9. The article management apparatus according to claim 7, wherein
the processor controls, when setting the node to be searched for as the next node, the wireless communication module to acquire the search result from the set next node.

10. An article management method for an article management apparatus that performs a search operation of searching for an article to be searched for and prints a search result of the search operation, the article management method comprising:
receiving, by a user interface, an input of search information from a user, the search information being information related to the article to be searched for;
receiving, by a tag reader, information from a wireless tag provided to an article located nearby;
building, by a wireless communication module, a mesh network between an own node and a plurality of other external nodes;
controlling the tag reader or the wireless communication module to perform the search operation based on the search information for each node of a communication path of the mesh network from the own node toward a terminal node in the plurality of other external nodes and acquire a search result; and
outputting, by an output device, the search result for each node of the communication path of the mesh network from the own node toward the terminal node.
